(19) United States
(12) Patent Application Publication
(10) Pub. No.: US 2024/0058817 A1
(43) Pub. Date: Feb. 22, 2024

(54) Microfluidics Chips Useful in Nanoparticle Preparation and Expandable Pump Network System Useful Therewith

(71) Applicant: The Regents of the University of Colorado, A Body Corporate, Denver, CO (US)

(72) Inventors: Uday Kompella, Centennial, CO (US); Jonathan Taylor, West Chester, PA (US)

(73) Assignee: The Regents of the University of Colorado, A Body Corporate, Denver, CO (US)

(21) Appl. No.: 18/359,810

(22) Filed: Jul. 26, 2023

Related U.S. Application Data
(63) Continuation of application No. PCT/US2022/013836, filed on Jan. 26, 2022.
(60) Provisional application No. 63/142,226, filed on Jan. 27, 2021.

(51) Int. Cl. B01L 3/00

(52) U.S. Cl. CPC B01L 3/502715; B01L 2400/0478; B01L 2300/023

(57) ABSTRACT

A system and method for nanoparticle synthesis employing an adhesiveless, deconstructable microfluidic mixing chip and an expandable wireless network of syringe pumps fluidly coupled to one or more microfluidic mixing chips. The wireless network of syringe pumps is controlled by a microprocessor with feedback from each of the syringe pumps in the network to allow for both individual, grouped and multiplexed control over the plurality of syringe pumps in the network.

### CROSS-REFERENCE TO RELATED APPLICATIONS

This is a continuation of and claims priority to co-pending Patent Cooperation Treaty International Application Serial No. PCT/US2022/013836, filed Jan. 26, 2022 designating the United States, which claims priority to U.S. Provisional Patent Application Ser. No. 63/142,226, filed Jan. 27, 2021.

### BACKGROUND

Microfluidics is the science of the manipulation of fluid through microchannels with dimensions of tens to hundreds of micrometers—these microchannels can be prepared with unique design features such as those which allow the mixing of multiple streams of fluids. By precisely controlling fluid mixing in unique microchannel architectures, pharmaceutical researchers apply microfluidics for molecular separation and analysis, organ-on-a-chip applications for reduced dependence on animal studies, and in the preparation of nanoparticles for encapsulating and delivering sensitive active pharmaceutical ingredients (APIs) such as nucleic acids. Microfluidics is not without limitations, however. In typical lab-scale batches, solutions are introduced to the microfluidic chip via a syringe where the plunger of the syringe is pushed by a syringe pump at a set rate. These pumps typically only allow constant velocity, and researchers are thus unable to study the effects of constant acceleration on the system. To control the delivery from multiple syringes, the current state-of-the-art technology relies on either A) pushing the plungers of multiple syringes with the same pump or B) using multiple syringe pumps. However, both approaches have limitations: approach A does not allow for the variation of flow rate between syringes, and the user is responsible for coordinating the operation of multiple syringe pumps for approach B. Both approaches greatly reduce the efficiency of pharmaceutical research and development including therapeutic nanoparticle research, which often requires prototyping dozens to hundreds of formulations to identify lead candidates with desirable physiochemical characteristics and API loading.

In 2015, the United States Food and Drug Administration (FDA) issued a statement recommending the production of all microencapsulated drugs be migrated to continuous flow manufacturing techniques. FDA guidance states continuous manufacturing integrates two-or-more unit operations; as the amount of unit operations increases, so does the complexity of the pumping control system. However, the current state-of-the-art syringe pump technology is inadequate to meet the needs present in continuous flow manufacturing. Thus, there is an unmet need for technologies to facilitate nanoformulation development from prototype-scale to production-scale.

Microfluidics is rapidly expanding in pharmaceuticals with its ability to reproducibly prepare drug-loaded nanoparticles. Producing nanoparticles in micrometer channels allows the user to define the fluid dynamic environment based on formulation and pumping parameters. A major advantage of these methods is the scale-up potential: continuous flow microfluidic manufacturing allows parallelization, i.e., running many chips in parallel to scale production. By pairing with an advanced pumping control system, rapidly scaled microfluidic nanomedicine production is possible. The ultimate goal of this development is a 100% end-to-end continuous flow microfluidic manufacturing process. Challenges remain before 100% end-to-end microfluidic manufacturing can be realized. Most commercial microfluidic chip companies make their chips out of borosilicate glass, cyclic olefin copolymer (COC), or polydimethylsiloxane (PDMS), each of which presents problems to the nanoparticle manufacturing process. Heat or chemical bound borosilicate glass and COC have a relatively low pressure tolerance compared to pressure joined polymers; this pressure limit can become an impasse in process development. PDMS has poor solvent compatibility, cannot handle high pressure, and the production of PDMS microfluidic chips themselves is not scalable. Additionally, borosilicate glass or PDMS microfluidic chips are made in two-dimensions or very rough three-dimensions. Herein, we address these drawbacks by presenting a microfluidic chip having: 1) tailored materials to fit need; 2) high pressure resistance; 3) high manufacturability; and 4) high-resolution 3D channel features.

The present invention is well positioned to meet the forgoing described needs. The expandable wireless network of syringe pumps described herein permits researchers to quickly incorporate additional syringe pumps to the microfluidic system. Additionally, the network allows for the implementation of process controls, in-process sampling, nanoparticle detectors, etc. that the current state-of-the-art technology is unable to accommodate. Using two or more syringe pumps and associated check valves, it is also possible to continuously infuse multiple liters of fluid from the same reservoir into the same chip. The various permutations possible with this system make it ideal for continuous manufacturing.

### SUMMARY OF THE DISCLOSURE

The present disclosure pertains to an improvement on conventional quartz or glass microfluidic chips by allowing chip manufacturing to become independent of the material used. Hybrid chips that incorporate different materials, such as multiple different plastics, different metals, plastics and metals, or the like become possible. Injection molding of microfluidic chips makes scaling of production possible. Further, electronic elements may be readily incorporated into the chip design.

High resolution 3D features may be both designed and implemented in the microfluidic chips of the present disclosure.

It is an objective of the present disclosure to provide microfluidic chips made of materials having high pressure resistance greater than 100 PSI.

It is a further objective of the present invention to provide microfluidic chips having plural complex chip layers with microfluidic channels on each chip layer.

It is still another objective of the present invention to provide microfluidic chips capable of being joined to each other or having plural chip layers joined to each other, such as by screws, tongue-and-groove joinery, or the like with sealing gaskets between adjacent layers and/or adjacent chips, such as a polytetrafluoroethylene (PTFE) gasket.

It is another objective of the present disclosure to also provide a network of smart syringe pumps having a base hub connected to a computer with running control software for controlling the syringe pumps. The base sends commands to each syringe pump in the network. Up to 3125 pumps can be in the network and be each sent multiple complex commands to control each syringe pump individually or in coordination with other pumps in the network.

It is a further objective of the present disclosure to allow each pump to send feedback to the base hub and to each other pump in the network, thereby allowing feedback regulation in the pumping programs.

It is a still further objective of the present disclosure to allow wireless communication in both the instructions from the base hub to each syringe in the network and in feedback from each syringe to the base hub and/or other syringes in the network.

It is yet still another objective of the present disclosure to provide a syringe pump network and base hub that is computer controlled to allow for simulation of complex biomimetic fluid flows such as blood pulsing, breathing, and tear production for organ-on-a-chip microfluidic applications.

These and other objectives, features, and advantages of the present disclosure will be more apparent from the following more detailed description taken with reference to certain non-limiting embodiments and the accompanying figures.

### BRIEF DESCRIPTION OF THE DRAWINGS

FIG. 1 is a photograph illustrating an exemplary syringe pump in accordance with the present invention.

FIG. 2 is an electrical schematic diagram of an exemplary programmable microcontroller, RF transceiver, stepper motor and stepper motor driver circuitry in accordance with an embodiment of the present invention.

FIG. 3 is a flow diagram illustrating a communication network topology in accordance with one embodiment of the present invention.

FIG. 4A is an exploded top perspective view of a microfluidic mixing chip in accordance with the present invention.

FIG. 4B is an exploded bottom perspective view of the microfluidic mixing chip in accordance with the present invention.

FIG. 5 is a flow diagram illustrating a method for making nanoparticles employing two wireless syringe pumps connected to a microfluidic mixing chip.

FIG. 6 is a flow diagram illustrating a method for making nanoparticles employing three wireless syringe pumps connected to two microfluidic mixing chips.

FIG. 7 is a graph illustrating the influence of total flow rate and flow rate ratio on nanoparticle mean diameter employing the wireless syringe pumps and microfluidic mixing chip of the present invention.

FIG. 8 is a graph illustrating drug loading of different drugs in poly(lactic-co-glycolic) acid (PLGA) nanoparticle preparations according for each of 10 μg and 5 μg cassettes.

### DETAILED DESCRIPTION OF THE DISCLOSURE

The terminology used herein is for the purpose of describing example embodiments only and is not intended to be limiting. For purposes of clarity, the following terms used in this patent application will have the following meanings:

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

When an element or layer is referred to as being “on,” “engaged,” “connected,” or “coupled” to or with another element, it may be directly on, engaged, connected or coupled to the other element or layer, or intervening elements or layers may be present. In contrast, when an element is referred to as being “directly on,” “directly engaged to,” “directly connected to,” or “directly coupled to” or with another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

“Substantially” is intended to mean a quantity, property, or value that is present to a great or significant extent and less than, more than or equal to totally. For example, substantially vertical may be less than, greater than, or equal to completely vertical.

“About” is intended to mean a quantity, property, or value that is present at ±10%. Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range, including endpoints given for the ranges.

Recitation of ranges of values herein are merely intended to serve as a shorthand method of referring individually to each separate value falling within the recited range, unless otherwise indicated herein, and each separate value is incorporated into the specification as if it were individually recited herein.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical, biomedical and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

This detailed description of exemplary embodiments makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

The present invention includes one or more syringe pumps each configured to deliver fluids, such as a pharmacologically active agent or drug, from a syringe to microfluidic chips to control fluid flow into, through and out of the microfluidic chips, microfluidic chips that receive fluid from the syringe and are configured to combine or mix the fluid with other chemical components within the microfluidic chip and output the combined or mixed fluid/chemical component from the microfluidic chip, and a network controller in communication with each of the syringe pumps that control each syringe pump individually or in a multiplexed fashion and receive feedback from each syringe pump to control the fluid dispensing from the syringe pump to the microfluidics chip.

Lab-variety syringe pumps deliver fluids from a syringe to microfluidic chips at a set rate until a pre-determined end point is attained. This controls fluid flow through microfluidic chips which typically incorporate multiple inlets and outlets. To use multiple syringe pumps connected to multiple microfluidic chip inlets, a user must typically coordinate the functions of multiple syringe pumps manually. As demonstrated by Kim, Y., et al., Mass production and size control of lipid-polymer hybrid nanoparticles through controlled microvortices. Nano Lett, 2012. 12(7): p. 3587-91, among many others, there is a direct relationship between pumping parameters and characteristics of nanoparticles created using a microfluidic chip capable of mixing aqueous and organic phases to prepare nanoparticles. Thus, researchers often analyze multiple sets of formulation and pumping parameters to identify formulation and pumping parameters which allow reproducible preparation of nanoparticle formulations with desired characteristics. However, current syringe pump technology renders this discovery phase time consuming and inefficient, and often leads to questionable fluid flow accuracy. Thus, syringe pump technology focused on simultaneous and efficient control of multiple pumps at varying rates will allow researchers to accelerate nanoparticle formulation development while conserving both time and material resources.

To address the limitations of the current state-of-the-art syringe pumping technology, a network controller to wirelessly and simultaneously monitor and control plural syringe pumps was developed to simultaneously deliver fluid through multiple syringes at varying rates. Further, the network controller receives feedback from each of the plural syringe pumps and adjusts control signals, as needed, to one or more of the plural syringe pumps to control fluid delivery to the microfluidics chips.

Prototypes of the inventive syringe pump were made using 3D printing for some parts using open-source files from Michigan Technological University (http://opensource.mtu.edu/). Other parts were sourced from commercially available suppliers.

In accordance with one embodiment of the invention, the syringe pump includes a syringe housing, a syringe piston, and a stepper motor that drives the syringe piston. A stepper motor driver is provided that controls the stepper motor. The stepper motor driver receives control signals from a programmable microcontroller. The programmable microcontroller, in turn, receives its commands from a radio frequency (RF) transceiver. A separate network base module consisting of an RF transceiver connected to a programmable microcontroller is used to transmit commands wirelessly from a computer to all syringe pumps in the network. Commands are sent to the base module from the computer via a USB or other suitable connection.

Control software operable on the computer allows the user to interact with the syringe pumps both individually and in groups of syringe pumps. The computer software allows the user to control multiple different flow rates and total volumes of the syringe pumps in the network. In this manner, users are able to simultaneously control up to 3125 syringe pumps in the network. This computer control over the flow rates and flow volumes from the syringe pumps allows for highly uniform flow rates without substantial pulsatile variations in the flow rate or flow volume from each of the syringe pumps.

In accordance with one embodiment, the embedded software was written in C++ and interprets commands from the computer and broadcasts commands to various nodes in the RF network. Python was used to write software with a graphical user interface (GUI) capable of designing experiments and sending commands for all syringe pumps in the network. Syringe pumps configured to send feedback to the base module which can then send information back to the computer, which is interpreted by the same Python GUI. Pumps are also able to communicate with other pumps.

In this manner, each of the syringe pumps in the network are controlled to deliver precisely metered microfluidic fluid flows into and through the microfluidic chips. Depending on the capacity of the syringe being used, each syringe pump is capable of controlling fluid flows between about 0.001 mL/min to 100 mL/min, with substantially uniform fluid flow without substantial pulsatile flow variations.

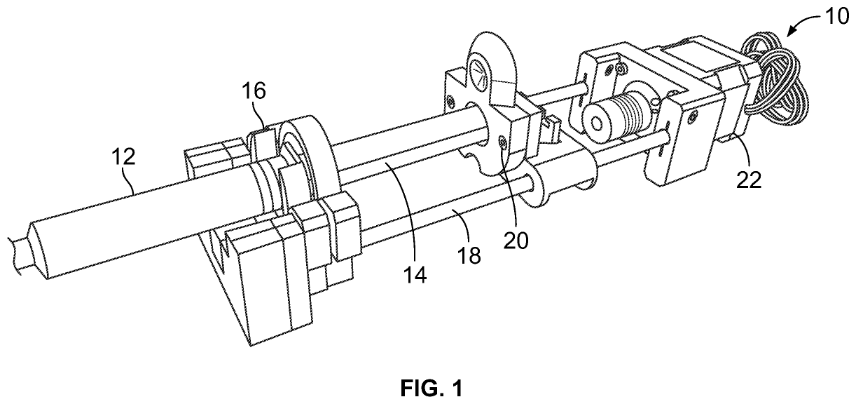

FIG. 1 illustrates an exemplary syringe pump assembly 10 in accordance with an embodiment of the present invention. Syringe pump assembly 10 includes a syringe housing 12, a syringe plunger 14, a mounting assembly 16 that secures the syringe housing 12 in a fixed position, the mounting assembly 12 also including guide rails 18 and a syringe plunger retainer 20 movably coupled to the guide rails 18 and fixedly coupled to the syringe plunger 14, and a stepper motor 22 that drives the syringe plunger retainer 20 in a linear and reciprocal fashion relative to the syringe housing 12.

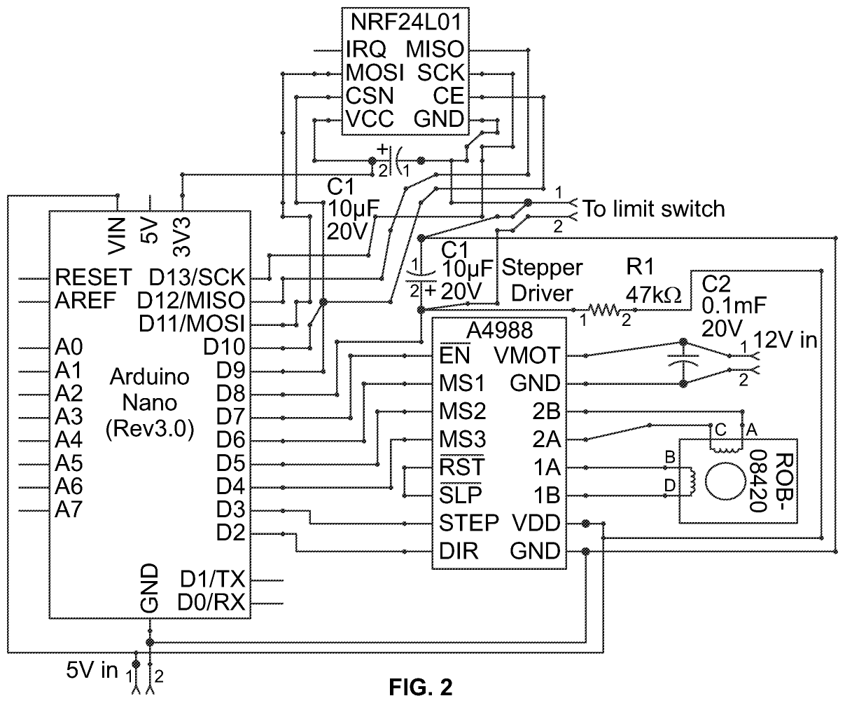

FIG. 2 illustrates an exemplary electrical schematic diagram of an exemplary programmable microcontroller, RF transceiver, and stepper motor driver circuitry in accordance with an embodiment of the present invention. In accordance with this exemplary embodiment, the programmable microcontroller is an ARDUINO NANO Rev. 3.0 (Arduino, Sommerville, MA, USA). The RF transceiver employed in the exemplary embodiment is an NRF24L01 (Arduino, Sommerville, MA, USA) wireless transceiver module operable in 2.4 GHz worldwide ISM frequency band and employing GFSK modulation for data transmission. Data transfer rate is selectable to be 250 kbps, 1 Mbps or 2 Mbps. Operating voltage of the RF transceiver module is between 1.9 to 3.6V and can be connected to any 5V logic microcontroller without using a logic level converter. The stepper motor driver may be an A4988 stepper motor driver employing an A4988 stepper motor driver chip on an A4988 stepper motor driver board. The A4988 stepper motor driver has output drive capacity of up to 35 V and ±2A and controls a bipolar stepper motor.

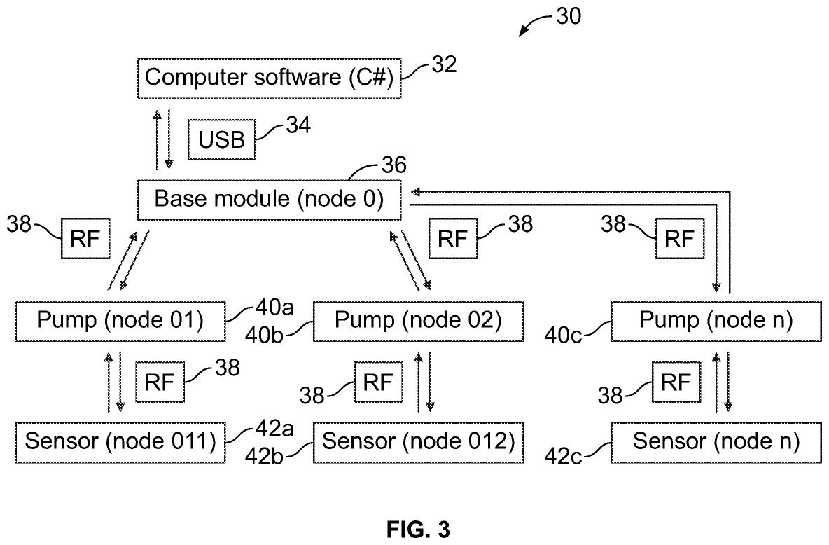

FIG. 3 is a diagram of the communication network topology 30. Information is sent from computer 32 over a USB 34. Commands are then broadcast from a base module 36 to syringe pumps 40a, 40b, 40c, wherein N is an integer less than or equal to 3125 throughout the network via RF transmission 38, preferably operating at 2.4 GHz or greater. This communication protocol enables advanced control over syringe pumping, including the implementation of feedback sensors 42a, 42b, 42c, wherein N is an integer less than or equal to 3125, at the syringe pump assembly that assist in controlling flow rate at each syringe pump 40a, 40b, 40c.

In accordance with an exemplary embodiment, control software was written in both C++ and Python that allows the user to interact with the syringe pump network. This control software allows a user to control multiple flow rates and total fluid volume on an individual or multiplexed syringe pump basis. Simultaneous control over up to 3125 syringe pumps is made possible by this system. Further, pump control software was written in C++ to receive and interpret commands from the computer and broadcast commands to different nodes in the RF network. Individual pumps are able to send feedback (such as current position) to the base module which, in turn, then sends information back to the computer. The RF network also enables inter-pump communication and data feedback to the base module and then to the computer.

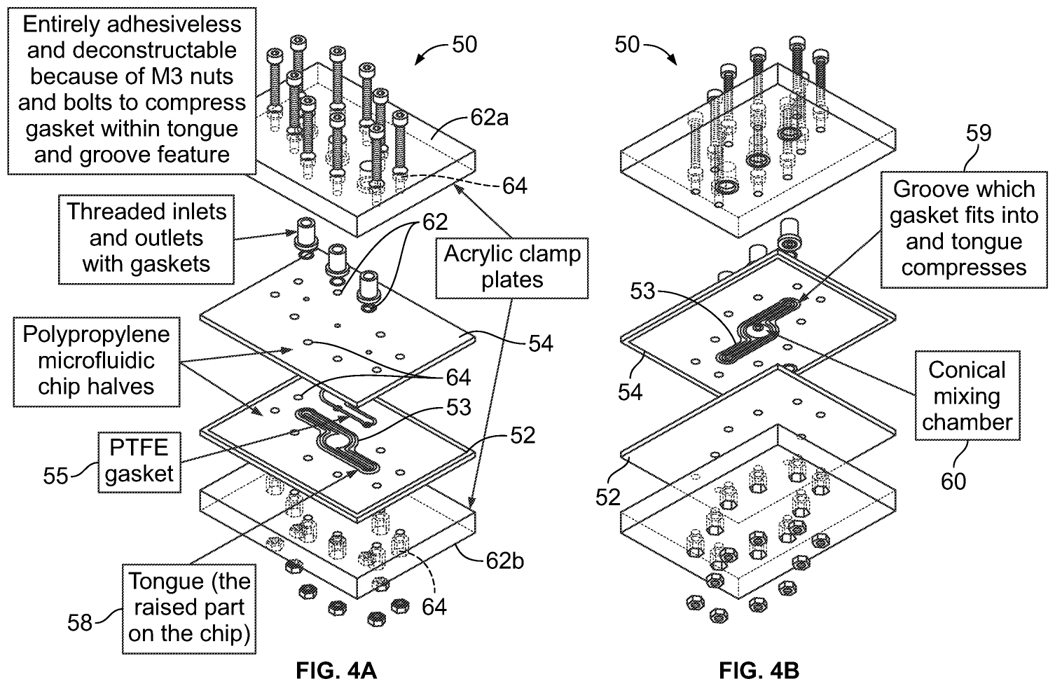

FIGS. 4A and 4B depict an exemplary microfluidic mixing chip construct, in which a tongue and grove feature is formed in mating surfaces of chip halves. A first chip half 52 has microfluidic channels 53 formed in a surface thereof, inlets and outlets 62 passing through the first chip half 52 to allow fluid flow into and out of the microfluidic channels 53, respectively. At least one gasket 55, such as polytetrafluoroethylene gaskets, seal the inlets and outlets 62, and seat within a groove 59 and are compressed by a tongue 58 on an opposing chip half that mates with the groove 59. A second chip half 54 has microfluidic channels 53 formed in a surface thereof which are configured to mate with the microfluidic channels 53 of the first chip half 52. The second chip half 54 also has either a tongue 58 or a groove 59 formed in the mating surface of the second chip half 54 and is configured to sealing engage with the tongue 58 or groove 59 of the first chip half 52. For example, if the first chip half 52 has a tongue 58, the second chip half 54 will have a groove 59 with which the tongue 58 mates. Conversely, if the first chip half 52 has a groove 59, the second chip half 54 will have a tongue 58 with that mates with the groove 59 of the first chip half 52 and compresses the gasket 55 in a sealing fashion.

A mixing chamber 60, preferably a conical mixing chamber, is formed in one or both of the first chip half 52 or the second chip half 54 and is in fluid flow communication with the microfluidic channels 53. In this manner, fluids containing the desired nanoparticle precursors are introduced into the microfluidic channels 53 through the inlets 62, enter the mixing chamber 60 and create a vortex within the mixing chamber 60 under flow pressure and flow volume conditions that mass produce the desired nanoparticles, as described in Ahn, J. et al., Microfluidics in nanoparticle drug delivery; From synthesis to pre-clinical screening. Adv Drug Deliv Rev, 2018. 128: p. 29-53. doi:10.1016/j.addr.2018.01.001, which is hereby incorporated by reference.

The first chip half 52 and the second chip half 54 are preferably made of a polymer and further are preferably made of polypropylene and/or polyethylene. Polypropylene and polyethylene have significantly higher solvent compatibility relative to traditional microfluidic polymers such as PDMS or PMMA. The microfluidic channels 52, tongue 58, groove 59, the inlets and outlets 62, and through holes 64 passing through each of the first chip half 52 and second chip half 54 are preferably formed by CNC micromachining each of the first 52 and second 54 chip halves.

Finally, the first 52 and second 54 chip halves are compressed together by employing opposing clamp plates 62a, 62b having through holes 64 in axial alignment with the through holes 64 in each of the first 52 and second 54 chip halves. Once aligned, nuts and bolts, such as M3 nuts and bolts are used to compress the first 52 and second 54 chip halves together causing gasket 55 to compress within the groove 59 and mate with the opposing tongue 58. This tongue-and-groove joinery with a seated gasket has been found to withstand higher fluid flow rates and pressures when compared to typical microfluidic chips that are bound by oxygen plasma treatment or infrared laser welding.

By employing the tongue-and-groove joinery with a gasket, the first and second chip halves are joined together without adhesive and are entirely deconstructable as the tongue 58 and groove 59 and gasket 55 sealing retain the first 52 and second 54 chip halves in a mated and joined condition under axial compression from the opposing clamp plates 62a, 62b.

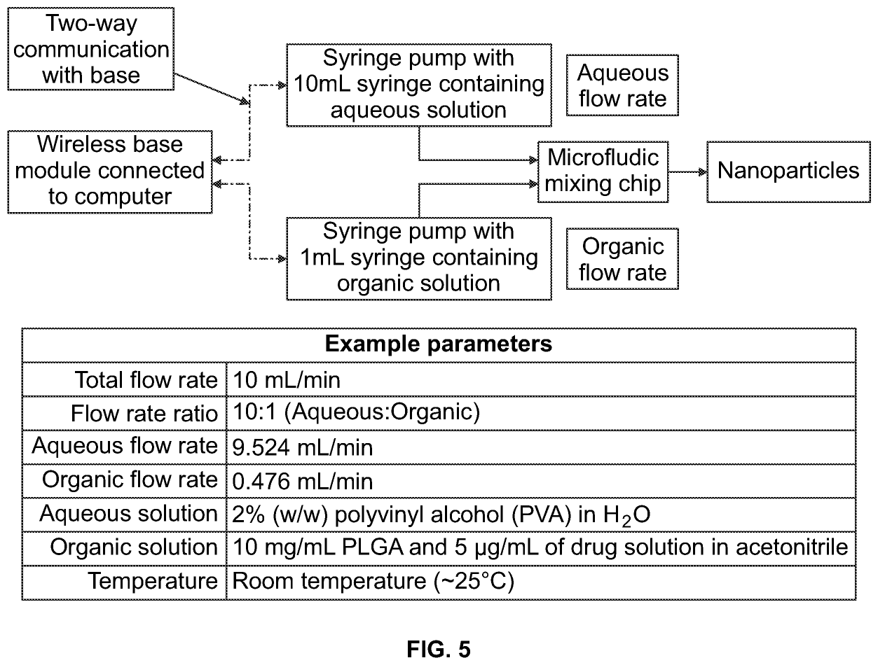

Turning now to FIGS. 5-8, there is illustrated to experimental processes of making nanoparticles containing drug solutions of twenty-one different drugs employing the above-described syringe network and microfluidic mixing chip constructs.

Example 1: As shown in FIG. 5, two syringe pumps under control of a computer, wireless base module connected to the computer, and two-way RF communication with the syringe pumps. A first syringe pump contained 10 mL of an aqueous solution of 2% (w/w) polyvinyl alcohol (PVA) in water and a second syringe pump contained 1 mL of an organic solution of 10 mg/mL poly(lactic-co-glycolic) acid (PLGA) and 5 μg/mL of drug solution in acetonitrile. The total flow rate was 10 mL/min, with an aqueous solution flow rate of 9.954 mL/min and an organic solution flow rate of 0.476 mL/min, for a flow rate ratio of 10:1 (aqueous:organic).

Example 2: The same experimental parameters were used as in Example 1, with the aqueous solution being 2% (w/w) PVA in water, except that the organic solution was 1 mL of organic of 30 mg/mL PLGA and 5 mg/mL of drug solution in acetonitrile, and a flow ratio of 20:1 (aqueous:organic).

FIG. 7 sets forth data on mean nanoparticle diameter (nm) relative to total flow rate (mL/min) for the 10:1 (aqueous:organic) flow rate in Example 1 and the 20:1 (aqueous:organic) flow rate in Example 2. It can readily be seen that the 10:1 aqueous:organic flow ratio resulted in relatively larger mean nanoparticle diameters of about 170-185 nm at 5 and 20 mL/min total flow rates, while the 20:1 aqueous:organic flow ratio resulted in larger nanoparticle mean diameters of about 185 nm at about 5 mL/min total flow rate, but far smaller mean nanoparticle diameters of about 140 nm at about 20 mL/min total flow rate and about 145 nm at about 27 mL/min total flow rate.

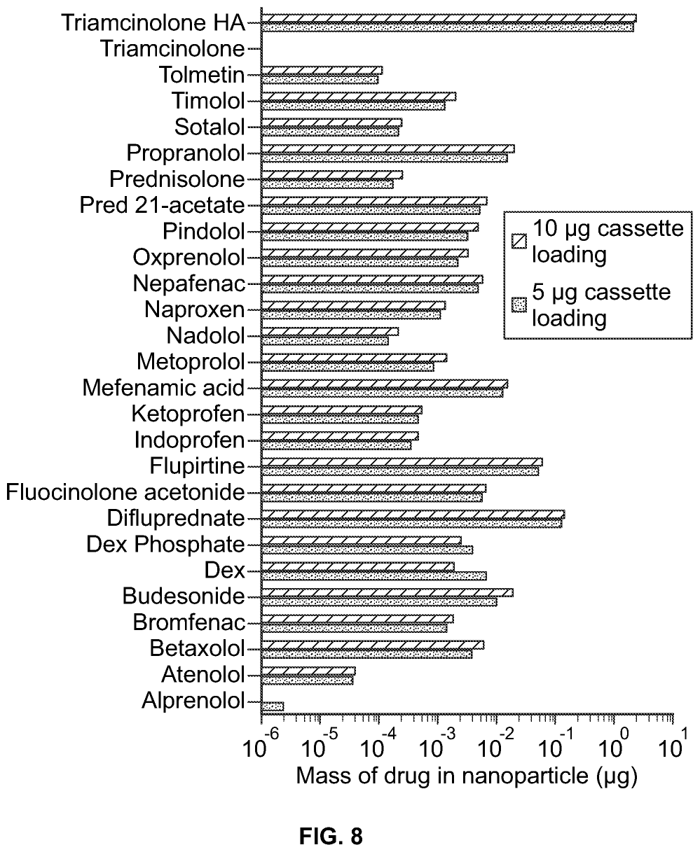

FIG. 8 is a graph of the mass of drug in μg in the nanoparticle, for each of 10 μg and 5 μg cassette loading for twenty-seven different drugs loaded in the organic solution. The drugs tested were triamcinolone HA, triamcinolone, tolmetin, timolol, sotalol, propranolol, prednisolone, prednisolone 21-acetate, pindolol, oxprenolol, nepafenac, naproxen, nadolol, metoprolol, mefenamic acid, ketoprofen, indoprofen, flupirtine, fluocinolone acetonide, difluprednate, dexamethasone sodium phosphate, dexamethasone, budesonide, bromfenac, atenolol, and alprenolol.

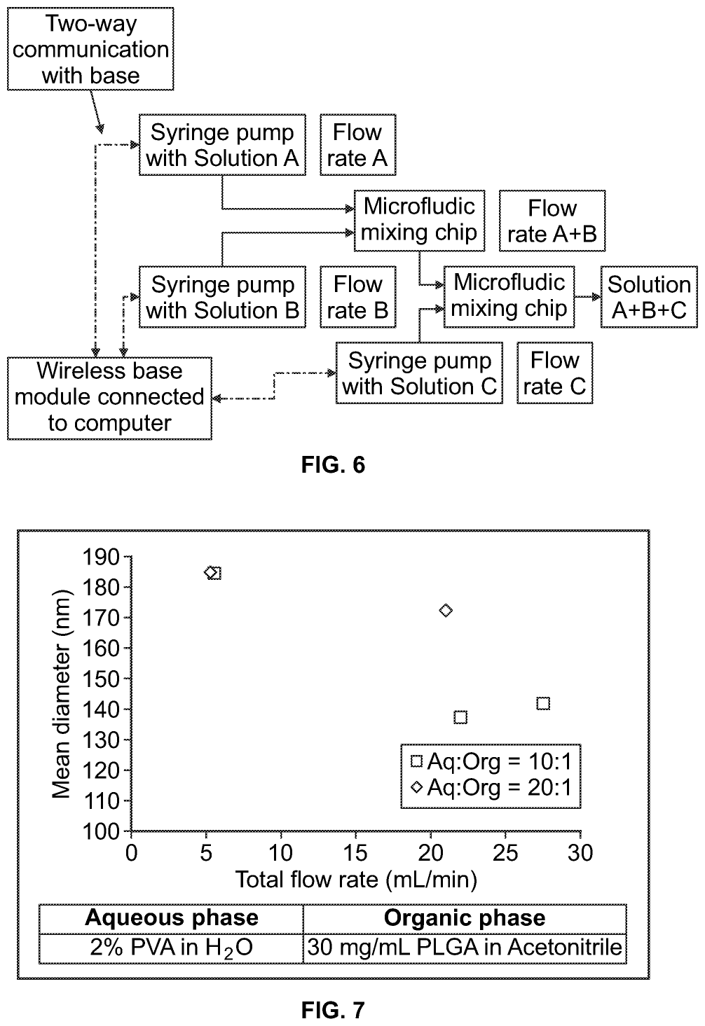

Example 3: FIG. 6 illustrates a three-solution nanoparticle synthesis employing the above-described syringe pump network and microfluidic mixing chip. Syringe pumps A, B, and C are wirelessly connected to a base module, which is in turn, connected to a control computer. Communications between the base module and each of the syringes is by wireless RF communication as described above. Syringe pump A has solution A and is operated at flow rate A. Syringe pump B has solution B and is operated at flow rate B, which is different than flow rate A. Solution A and Solution B are input into a microfluidic mixing chip at a combined flow rate A+B. Syringe pump C has solution C and is introduced into a separate microfluidic mixing chip at a flow rate C, for a combined flow rate of A+B+C. Solution A may be the aqueous solution, while solutions B and C may be organic solutions having two different drugs to be formed into the nanoparticles.

While the present invention has been disclosed with reference to exemplary embodiments, those skilled in the art will understand and appreciate that variations in materials, dimensions, concentrations, volumes, flow rates, pressures, and structural constructs may be made without departing from the scope of the present invention, which is intended to be limited only by the claims appended hereto.

### REFERENCES

1. Whitesides, G. M., The origins and the future of microfluidics. Nature, 2006. 442(7101): p. 368-73.
2. Destremaut, F., et al., Microfluidics with on-line dynamic light scattering for size measurements. Lab Chip, 2009. 9(22): p. 3289-96.
3. Seo, J., et al., Multiscale reverse engineering of the human ocular surface. Nat Med, 2019. 25(8): p. 1310-1318.
4. Seqqat, R., et al., Nanoparticles for Environment, Engineering, and Nanomedicine. Journal of Nanotechnology, 2019. 2019: p. 1-2.
5. Navarro, F., On-target delivery: lipid-based system introduces a novel approach for an HIV vaccination, in Drug development and delivery. 2019, Ralph Vitaro: USA. p. 6.
6. Kimura, N., M. Maeki, and M. Tokeshi, Microfabrication and microfluidic devices for drug delivery, in Microfluidics for Pharmaceutical Applications. 2019. p. 123-136.
7. Ahn, J., et al., Microfluidics in nanoparticle drug delivery; From synthesis to pre-clinical screening. Adv Drug Deliv Rev, 2018. 128: p. 29-53. doi:10.1016/j.addr.2018.01.001.8.

What is claimed is:

1. A syringe pump in fluid flow communication with at least one microfluidic chip, comprising:
(a) A syringe housing and a syringe plunger;
(b) A syringe pump assembly having a syringe housing retainer, a syringe plunger retainer, and at least one guide rail operably coupled to the syringe plunger; and
(c) A stepper motor operably coupled to the syringe plunger retainer and operable to apply a motive force to the syringe plunger and deliver fluid within the syringe housing to the at least one microfluidic chip at a substantially uniform flow rate.

2. The syringe pump of claim 1, further comprising a stepper motor driver in communication with the stepper motor.

3. The syringe pump of claim 2, further comprising a microprocessor in communication with the stepper motor driver.

4. The syringe pump according to claim 1, further comprising plural syringe pumps under the control of the microprocessor.

5. The syringe pump of claim 4, further comprising an RF transceiver in wireless communication with each of the plural syringe pumps and in communication with the microprocessor.

6. The syringe pump according to claim 1, wherein the substantially uniform flow rate is characterized by not having substantial pulsatile flow variations.

7. The syringe pump according to claim 6, wherein the substantially uniform flow rate is between 0.001 mL/min and 100 mL/min.

8. A system for delivering substantially uniform flow rates to a microfluidic chip from one or more syringe pumps, comprising:
a syringe pump assembly including a syringe housing, a syringe plunger, a syringe housing retainer, a syringe plunger retainer, a support structure including at least one guide rail to which the syringe plunger retainer is operably coupled, and a stepper motor operably coupled to the syringe plunger retainer and configured to apply a motive force to the syringe plunger;
a microprocessor;
a stepper motor driver;
an RF transceiver;
control software in communication with the microprocessor, stepper motor driver and RF transceiver, wherein the microprocessor communicates with the RF transceiver and the stepper motor driver to receive syringe pump flow rate and flow volume information and wirelessly transmit the flow rate and flow volume information to the syringe pump, thereby activating the stepper motor to drive the syringe plunger into the syringe housing in response to the pump flow rate and flow volume information to communicate fluid within the syringe housing to the microfluidic chip at a substantially uniform flow rate.

9. The system of claim 8, further comprising at least one feedback sensor operably coupled to the one or more syringe pumps and in communication with the microprocessor.

10. The system of claim 9, further comprising plural syringe pumps in a network under common control of the control software.

11. The system of claim 8, wherein the microfluidic chip further comprises at least two chip halves, one of the at least two chip halves having a tongue projection formed on a mating surface thereof and a second of the at least two chip halves having a groove recess formed on a mating surface thereof, and a gasket positioned in the groove, such that when the at least two chip halves are mated at their mating surfaces, the tongue projection and the groove recess interface with each other and are sealing connected by the gasket in a tongue-and-grove joinery, thereby forming an adhesiveless and deconstructable mating of the at least two chip halves.

12. The system of claim 11, wherein the microfluidic chip further comprises a least two microfluidic channels having separate fluid inlets.

13. The system of claim 11, wherein the microfluidic chip further includes a mixing chamber in fluid flow communication with the at least two microfluidic channels.

14. The system of claim 8, wherein the substantially uniform flow rate is characterized by not having substantial pulsatile flow variations.

15. The system of claim 14, wherein the substantially uniform flow rate is between 0.001 mL/min and 100 mL/min.

16. A microfluidic chip, comprising at least two chip halves, each of the at least two chip halves having mating surfaces and microfluidic channels formed in the mating surfaces thereof, a first chip half includes a tongue projection formed on a mating surface thereof and circumscribing the microfluidic channel therein, and a second chip half having a groove recess formed on a mating surface thereof and circumscribing the microfluidic channel therein, and a gasket positioned in the groove, such that when the first and second two chip halves are mated at their mating surfaces, microfluidic channels, the tongue projection and the groove recess interface with each other and are sealing connected by the gasket in a tongue-and-grove joinery, thereby forming an adhesiveless and deconstructable mating of the at least two chip halves.

17. The system of claim 16, wherein the microfluidic chip further comprises a least two microfluidic channels having separate fluid inlets.

18. The system of claim 16, wherein the microfluidic chip further includes a mixing chamber in fluid flow communication with the at least two microfluidic channels.

19. The system of claim 18, wherein the mixing chamber is configured to generate a vortex fluid flow within the mixing chamber.

20. The system of claim 16, wherein the each of the at least two chip halves further comprise at least one of polyethylene or polypropylene.
